(19) United States
(12) Patent Application Publication
(10) Pub. No.: US 2012/0091099 A1
(43) Pub. Date: Apr. 19, 2012

(54) METHODS AND APPARATUS FOR RECOVERY AND REUSE OF REAGENTS

(75) Inventors: MICHAEL KIEFER, Neuhausen (DE); ANDREAS NEUBER, Stuttgart (DE); DENIS DAVID, Crolles (FR); DANIEL O. CLARK, Pleasanton, CA (US); PHIL CHANDLER, Clifton (GB)

(73) Assignee: APPLIED MATERIALS, INC., Santa Clara, CA (US)

(21) Appl. No.: 13/238,721

(22) Filed: Sep. 21, 2011

Related U.S. Application Data
(60) Provisional application No. 61/394,163, filed on Oct. 18, 2010.

(51) Int. Cl. C23F 1/00; B08B 3/08; B08B 7/00; C23F 1/08

(52) U.S. Cl. 216/93; 156/345.18; 134/109; 134/10

(57) ABSTRACT

Methods and apparatus for recovery and reuse of reagents are provided herein. In some embodiments, a system for processing substrates may include a process chamber for processing a substrate; a reagent source coupled to the process chamber to provide a reagent to the process chamber; and a reagent recovery system to collect, and at least one of purify or concentrate the reagent recovered from an effluent exhausted from the process chamber. In some embodiments, a method for recovering unreacted reagent may include providing reagent from a reagent source to a process chamber; exposing a substrate disposed in the process chamber to the reagent, forming an effluent; exhausting the effluent from the process chamber; and recovering unreacted reagent from the effluent in a reagent recovery system.

### CROSS-REFERENCE TO RELATED APPLICATIONS

This application claims benefit of U.S. provisional patent application Ser. No. 61/394,163, filed Oct. 18, 2010, which is herein incorporated by reference.

### FIELD

Embodiments of the present invention generally relate to apparatus for processing substrates.

### BACKGROUND

In semiconductor, flat panel, photovoltaic, nanomanufacturing, organic light emitting diode (OLED), and other silicon or thin film processing systems, may use hazardous chemicals, such as acids, for example, hydrofluoric acid (HF), nitric acid (HNO₃), phosphorus acid (H₃PO₄) for a variation of processes, such as wet etching, substrate or chamber cleaning, substrate surface roughening or the like. Unfortunately, due to their hazardous nature, production, storage and transportation of these chemicals can raise several safety concerns. Further, once these chemicals are used in the cleaning, etching, or surface roughening processes, reaction byproducts, including acidic water, particulate, and metal ions are exhausted. Unfortunately, these exhausted effluents, including acids, metals, particulates, and fluorine ions are often toxic and corrosive requiring further treatment and/or disposal.

### SUMMARY

Methods and apparatus for recovery and reuse of reagents are provided herein. In some embodiments, a system for processing substrates may include a process chamber for processing a substrate; a reagent source coupled to the process chamber to provide a reagent to the process chamber, and a reagent recovery system to collect, and at least one of purify or concentrate the reagent recovered from an effluent exhausted from the process chamber.

In some embodiments, the recovery system may be adjacent to the process chamber. In some embodiments, the recovery system may be a distance away from the process chamber, such as within another facility. In some embodiments, the reagent recovery system may be coupled to the process chamber or several process chambers. In some embodiments, the reagent may comprise at least one of hydrofluoric acid (HF), nitric acid (HNO₃), or phosphoric acid (H₃PO₄). In some embodiments, the recovered reagent may be used in one or more of the same process chamber or a different process chamber. In some embodiments, the recovered reagent may be provided to one or more of the same process chamber or a different process chamber to perform a process using only recovered reagents. In some embodiments, the recovered reagent may be mixed with a fresh reagent and may be provided to one or more of the same process chamber or a different process chamber to perform a process. In some embodiments, the fresh reagent may have a different chemical composition from the recovered reagent. In some embodiments, recovered reagents have different chemical compositions may be mixed together and provided to the same or a different process chamber to perform a process. In some embodiments, the recovered reagent or a mixture of recovered reagents, or a mixture of a recovered reagent and a fresh reagent may be anhydrous. In some embodiments, the recovered reagent or a mixture of recovered reagents, or a mixture of a recovered reagent and a fresh reagent may have a water concentration ranging from about 0 to almost 100 percent.

In some embodiments, a system for processing substrates may include a process chamber for processing a substrate with a liquid reagent, a reagent source coupled to the process chamber to provide the liquid reagent to the process chamber; and a reagent recovery system to collect reagent removed from the process chamber and to purify and adjust the concentration of the collected reagent to a concentration and purity suitable for use in the process chamber. In some embodiments, the liquid reagent may be a mixture of two or more liquid reagents. In some embodiments, the collected reagent may be used for processes including one or more of clean, wet etch, or surface roughening.

In some embodiments, In some embodiments, a method for recovering unreacted reagent may include providing reagent from a reagent source to a process chamber; exposing a substrate disposed in the process chamber to the reagent, forming an effluent; exhausting the effluent from the process chamber; and recovering unreacted reagent from the effluent in a reagent recovery system. In some embodiments, the reagent recovery system may be coupled to the process chamber. In some embodiments, the reagent may comprise at least one of hydrofluoric acid (HF), nitric acid (HNO₃), or phosphoric acid (H₃PO₄). Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic of a processing system in accordance with some embodiments of the present invention.

FIG. 2 depicts a detailed view of abatement system and reagent recovery system of the processing system of FIG. 1 in accordance with some embodiments of the present invention.

FIG. 3 depicts a flow chart for a method of recovering reagent in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention relate to methods and apparatus for recovering and reusing of reagents. At least some embodiments of the inventive methods and apparatus may advantageously provide for both recovering of unreacted reagents and conversion of byproduct species from an exhausted effluent into useable reagents. At least some embodiments of the inventive methods and apparatus may reduce the need for production, transportation, and/or storage of hazardous chemicals (e.g., the reagents) by recovering reagents from the exhausted effluent and converting the recovered reagent to a form suitable for reuse.

For example, in some embodiments, waste reagent from applications such as etching, cleaning, surface roughening or texturing, surface treatment or doping, or the like may be collected (e.g., recovered) and purified to remove process byproducts, such as trace metal ions, particulates, and silicates, to a satisfactory level. The purified recovered reagent may then be vacuum distilled to make the recovered reagent the appropriate concentration, mixture, and/or purity to be useful in the aforementioned processes.

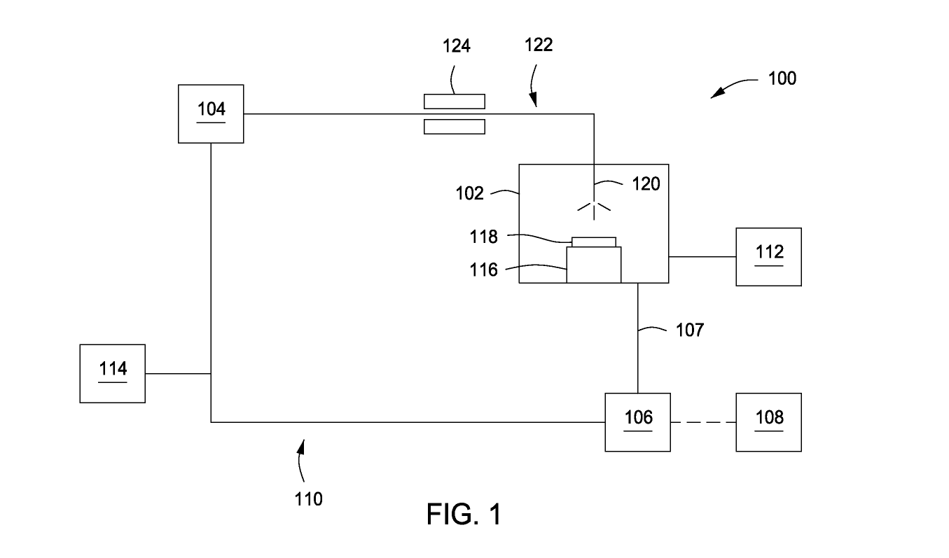

An exemplary semiconductor processing system 100 in accordance with at least some embodiments of the present invention is schematically illustrated in FIG. 1. The semiconductor processing system 100 includes a process chamber 102 for processing a substrate and a reagent source 104 coupled to the process chamber 102. The process chamber 102 (or any other process chamber described herein) may be any suitable process chamber for processing a substrate using reagents as described herein. In some embodiments, the process chamber 102 may be configured for performing wet processes. As used herein, the term process chamber is intended to include all substrate processing apparatus wherein a substrate is processed using reagents as discussed herein. For example, the process chamber may be a vacuum chamber, a non-vacuum chamber, a wet bench, a wet station, or the like. Non-limiting examples of process chambers also include substrate processing apparatus used for wet etch, wet clean, surface treatment, or surface roughening of substrates.

The reagent source 104 provides one or more reagents to the process chamber to process a substrate disposed within the process chamber 102, and, optionally, other components, for example, such as other process chambers and/or process equipment in a fabrication (FAB) line that may utilize one or more of the reagents provided by the reagent source 104. In some embodiments, the reagents may be liquid reagents. Non-limiting examples of reagents may include hydrofluoric acid (HF), nitric acid (HNO₃), phosphoric acid (H₃PO₄), other acids, etching agents, cleaning agents, or combinations thereof. A reagent recovery system 106 may be coupled to the process chamber 102, for example, via a waste effluent line 107 to recover reagents removed from the process chamber 102. The reagent recovery system 106 may recover reagents received directly from the process chamber, and/or received from an effluent from an abatement system (such as the abatement system 108).

The reagent recovery system 106 may be configured to recover the reagents directly from the process chamber 102 and/or to recover reagents after passing the effluent stream through the abatement system 108. The reagent recovery system 106 may be configured to collect, purify, and concentrate the reagents. The reagent recovery system 106 may be integral with the abatement system 108, partially integrated with the abatement system 108, or separate from the abatement system 108. In the embodiment depicted in FIG. 1, the reagent recovery system 106 may be disposed along a conduit 110 coupling the reagent recovery system 106 and the reagent source 104.

In some embodiments, the conduit 110 may couple the reagent recovery system 106 to the reagent source 104 and may be utilized for providing the recovered reagent to the reagent source 104. The recovered reagents may be utilized by the reagent source 104 to provide reagents to be utilized in the process chamber 102. A controller 112 may be provided to control the operation of the process chamber 102, the reagent source 104, the reagent recovery system 106, and the abatement system 108. The system 100 need not be limited to a closed-looped system. Alternatively or in combination, the conduit 110 may be coupled to a second process chamber 114 for providing the recovered reagents to the second process chamber 114.

The semiconductor processing system 100 described above is merely exemplary and other processing systems are possible, for example, a processing system having two or more process chambers coupled to the same reagent recovery system, a process chamber coupled to multiple reagent recovery systems, where each reagent recovery system may be configured for processing a specific effluent, a reagent source coupled to two or more process chambers and fueled by recovered reagents from one or more reagent recovery systems, or the like.

The process chamber 102 may be any suitable processing chamber configured for liquid processes having incoming liquid reagents in need of being abated and reused in the process chamber 102 and/or in another process chamber or in other process equipment of a fabrication (FAB) line that utilizes the liquid reagents. Suitable processing chambers may include any single wafer or batch cleaning system, such as a chamber configured for wet chemical etch or clean, such as pre-thermal or post-strip wet cleans, acid texturing etch, spray doping, or the like.

As shown in FIG. 1, the process chamber 102 may include a substrate support 116 for holding a substrate 118. The substrate 118 may be any suitable material to be processed, such as a crystalline silicon (e.g., Si<100> or Si<111>), a silicon oxide, a strained silicon, a silicon germanium, a doped or undoped polysilicon, a doped or undoped silicon wafers, patterned or non-patterned wafers, silicon on insulator (SOI), carbon doped silicon oxides, silicon nitride, doped silicon, germanium, gallium arsenide, glass, sapphire, a display substrate (such as a liquid crystal display (LCD), a plasma display, an electro luminescence (EL) lamp display, or the like), a solar cell array substrate, a light emitting diode (LED) substrate, or the like. The substrate 118 may have various dimensions, such as 200 mm or 300 mm diameter wafers, as well as rectangular or square panels. The frontside surface of the substrate 118 may be hydrophilic, hydrophobic, or a combination thereof. The frontside surface may be patterned, or having one or more patterned layers, such as a photomask, disposed thereon.

In some embodiments, the substrate 118 may be disposed in a recess (not shown) formed on the surface of the substrate support 116. The recess may be utilized, for example, to immerse the substrate 118 in bath of the reagent. The reagent may be supplied, for example, by a nozzle 120 disposed above the support 116. The recess need not be limited to a depression formed in the surface of the substrate support. As such, the recess may be formed, for example, by a edge ring or bracket (not shown) configured to support the substrate 118 at a peripheral of the substrate, where the substrate 118 forms the base of the recess.

The nozzle 120 may be coupled to the reagent source 104 via an incoming fluid line 122. The nozzle can be positioned to direct flow of a liquid onto the frontside surface of the substrate 118. In some embodiments, the nozzle 120 may dispense a reagent to fill the recess, thus immersing the frontside surface of the substrate 118 in the reagent. In some embodiments, the nozzle may dispense a reagent to be spread uniformly across the frontside surface of the substrate 118. For example, the frontside surface may be covered with a reagent by dispensing the reagent from the nozzle at a flow rate sufficient to cover the frontside surface of the substrate 118 with the reagent while maintaining a rotation rate sufficient to cover the frontside surface with the reagent.

The reagent source 104 may be coupled to the process chamber 102 via the incoming fluid line 122 to provide the liquid reagent to the process chamber 102, for example, via the nozzle 120. Optionally, a thermal control device 124 may be disposed along the fluid line 122 for heating or cooling the liquid reagent flowing therethrough prior to use in the process chamber 102. The thermal control device 124 may be disposed at any suitable point along the fluid line 122, for example, as close as possible to the process chamber 102 to minimize heat loss. The thermal control device 124 may be, for example, a point of use heater, or other suitable heating apparatus for heating a reagent to a desired temperature, or a heat exchanger, peltier device, or other mechanism for cooling the reagent to a desired temperature. For example, in some embodiments, the liquid reagent supplied by the reagent source 104 may be at a temperature of between about 15 to about 30 degrees Celsius. In some embodiments, the thermal control device 124 may control the liquid reagent to a temperature of between about 35 to about 90 degrees Celsius.

The waste effluent line 107 may include, or may be coupled to, a pumping system (not shown) that moves effluent from the process chamber 102 and into the reagent recovery system 106. In some embodiments, the reagent recovery and or delivery system may employ a Teflon encapsulated, magnetically levitated pumping and metering system, such as a Levitronix pump, to move fluid throughout the system while avoiding particulate or metals contamination common in shaft seal pumps. Alternately, fluoropolymer encapsulated diaphragm pumping systems may be employed. Any liquid, liquid mixture, substrate material, deposited materials, removed materials, or combinations thereof may comprise and/or combine to form effluent that is exhausted from the process chamber 102, for example, via the waste effluent line 107. The effluent may include un-reacted or excess portions of reagents, such as HF, HNO₃, H₃PO₄, or combinations thereof used for processing the substrate or cleaning the chamber and/or chamber components such as re-usable process kits or process kit shields. The effluent generated in these processes can include different compositions of flammable and/or corrosive compounds, micron to sub-micron sized process residue particulates and gas phase nucleated materials, and other hazardous or environmentally polluting compounds. For example, the effluent may contain different compositions of halogen containing gases, perfluorocompounds (PFCs), chlorfluorocompounds (CFCs), hazardous air products (HAPs), volatile organic compounds (VOCs), and the like. In some embodiments, the effluents may include fluorine-containing effluents, for example, compounds formed from reactions with reagents from the reagent source 104 and materials present in the process chamber 102. Exemplary byproduct species may include one or more of fluorine-containing effluents, such as fluoride (F⁻), or other acid ionic species, metal ions, particulates, water, organics, silicon oxide (SiO₂), silicon tetrafluoride (SiF₄), nitrogen trifluoride (NF₃), carbon tetrafluoride (CF₄), oxyfluorosilicates, silicon fluorohydrides (SiFₓH), perfluorocompounds (PFCs), or combinations thereof.

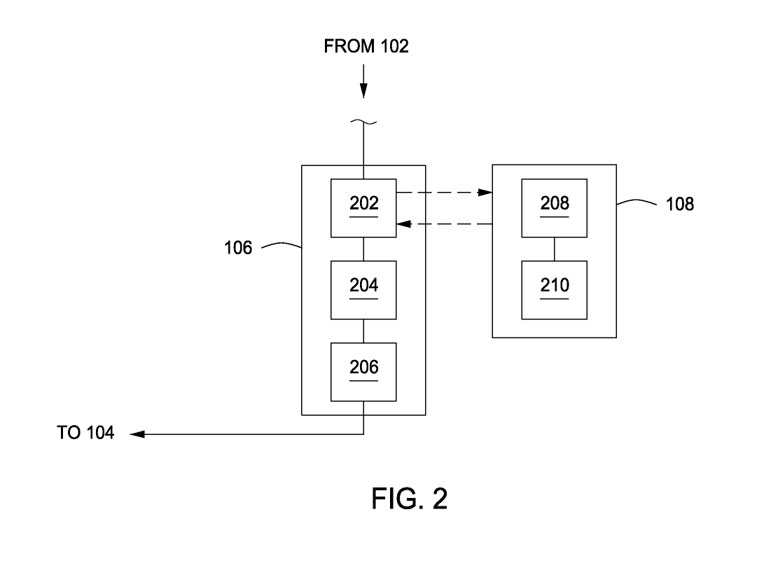

Effluent from the process chamber (disposed via the waste effluent line 107) is directed to the reagent recovery system 106. The reagent recovery system 106 operates to recover one or more unreacted reagents from the effluent stream and, in combination with the abatement system 108, may be utilized to convert at least a portion of the effluents, such as fluorine-containing effluents or the like, into reagents, such as HF, or the like. The reagent recovery system 106 (illustrated in detail in FIG. 2), may at least one of collect, purify, or concentrate the recovered the one or more reagents to an appropriate concentration and appropriate mixture for each application. After recovery, the recovered reagents may then be used for another process, such as by being flowed to the reagent source 104 via the conduit 110, or provided to another process chamber. The reagent recovery system 106 may be integral with, partially integrated with, or completely separate from the abatement system 108.

In some embodiments, the reagent recovery system 106 may include one or more of a scrubber 202, a vacuum distillation apparatus 204, or a bubbler 208. The recovered reagents may be collect and/or purified by either or both of the scrubber 202 and the vacuum distillation apparatus 204. The recovered reagents may be diluted by a bubbler 210. The reagent recovery system 106 is exemplary, and other variants of the system are possible. For example, in some embodiments, the scrubber 202 may be part of the abatement system 108. For example, the vacuum distillation apparatus 204 may be used in combination with, or replaced by, any one or more of an ion exchange apparatus, continuous electrodeionization (CEDI) apparatus, reverse osmosis apparatus, electrodialysis apparatus, membrane distillation apparatus, or the like.

In operation, for example, the effluents, including the unreacted reagents and byproduct species may enter the reagent recovery system 106 and initially be collected and purified by the scrubber 202. The scrubber 202 may be any suitable scrubber utilized with abatement processes, such as a hydrocyclone, a liquid particulate scrubber, or a liquid scrubber (e.g., a water scrubber) or the like. For example, in water scrubbing, the unreacted reagents and byproduct species are brought into contact with water, using methods, such as bubbling or otherwise mixing the unreacted reagents and byproduct species through a water spray or the like to remove undesirable species. Some materials (e.g., unreacted reagents), such as acids which are soluble or water reactive, may be collected by the scrubber 202. Other materials, for example, byproduct species which are insoluble in water may be removed by the scrubber 202. Other byproduct species which are water soluble, if any, may also be collected by the scrubber in addition to the unreacted reagents.

After scrubbing, the water soluble materials, e.g., the unreacted reagents and any additional water soluble byproduct species, may be flowed from the scrubber 202 to the vacuum distillation apparatus 204. As discussed above, the vacuum apparatus 204 may be used in combination with, or replaced by one or more of the apparatus discussed above. The vacuum distillation apparatus 204 may include a distillation column or a vacuum distillation column for distilling the unreacted reagent from the water soluble byproduct species. This vacuum distillation column may be made of glass, quartz, boron free glass, polymeric, fluoro polymers such as Teflon or Halar, or metal, depending on requirements for the reagents being processed. The distillation column may be kept at a pressure below atmospheric pressure, such that the most volatile chemical species (e.g., those species with the lowest boiling points) will evaporate first. Accordingly, and for example, species having a low boiling point can be separated from the remaining water soluble byproduct species having higher boiling points.

In some embodiments, the materials recovered from the vacuum distillation apparatus 204 include the unreacted reagent and some residual water (H₂O) content. However, the concentration of the unreacted reagent in water may be too high and require dilution prior to use. In this case the recovered reagent may not be suitable for use in this reagent source 104, but in another component of a FAB line, such as the second process chamber 114. Alternately, the recovered reagent(s) may not be of sufficient quality to be reused for a treatment cycle requiring highest purity, but may be used in an alternate process cycle or an earlier cycle not requiring as high a reagent purity. Accordingly, the bubbler 206 may be utilized to adjust the concentration of the unreacted reagent prior to flowing the unreacted reagent to the reagent source 104. For example, the unreacted reagent may be diluted by bubbling the unreacted reagent through a water spray or a similar bubbling process used to adjust the concentration of a material. After the concentration of the unreacted reagent is adjusted by the bubble to be suitable for use in the reagent source, the unreacted reagent is flowed to the reagent source 104 via the conduit 110.

In some embodiments, the unreacted reagent may require further concentration. Accordingly, the reagent recovery system may further comprise an apparatus for concentrating the unreacted reagent, for example, such as by a process including one or more of membrane processes, electrically assisted membrane processes, ion exchange processes, or freezing processes designed to increase concentration. In another embodiment fresh reagent is added to increase concentration to target levels. One exemplary apparatus that may be used to increase the concentration of the unreacted reagent in water is a vacuum distillation column. For example, the vacuum distillation column may be part of the vacuum distillation apparatus 204 or a separate vacuum distillation apparatus that may receive the materials recovered from the vacuum distillation apparatus 204 include the unreacted reagent and some residual water (H₂O) content. For example, the vacuum distillation apparatus 204 may include a first distillation column for that may recover the materials including the unreacted reagent and some residual water (H₂O) content as discussed above, and a second distillation column to further recover the unreacted reagent from the materials such as the residual water (H₂O) and/or any other materials to further concentrate the unreacted reagent. The vacuum distillation apparatus 204 or the separate vacuum distillation apparatus used to concentrate the unreacted reagent may include any suitable number of distillation columns necessary to achieve the desired concentration of the un unreacted used reagent.

The above described embodiments of the reagent recovery system 106 are merely exemplary and other embodiments are possible. For example, in some embodiments, a scrubber may be omitted and the exhausted effluents may flow directly from waste effluent line 107 to at least one of the vacuum distillation apparatus 204 or other similarly purposed apparatus as discussed above to recover one or more reagents from the exhausted effluent. Alternatively, the scrubber may be located after the vacuum distillation apparatus 204 to remove water soluble byproduct species from the remaining effluents post-vacuum distillation.

In some embodiments, the exhausted effluent may comprises two or more reagents, for example, such as a mixture of reagents from the same process chamber, or different individual reagents flowed to the reagent recovery system 106 from different process chambers. In some embodiments, the two or more reagents may be recovered simultaneously as a mixture via one or more embodiments of the reagent recovery system 106 as discussed above. The recovered mixture of the two or more reagents may then be utilized in one or more of the same or a different process chamber for a process that utilizes a mixture of the two or more reagents. Alternatively, the recovered mixture of the two or more reagents could be separated into individual reagents and each individual reagent could be utilized in one or more of the same or a different process chamber.

Alternatively, one of the two or more reagents may be recovered via one of more embodiments of the reagent recovery system 106 as discussed above, and the other(s) of the two or more reagents may be disposed of as waste.

Alternatively, the two or more reagents may be separated prior to entering the reagent recovery system 106. For example, each reagent may be separated from the two or more reagents, and then each reagent may independently enter the reagent recovery system 106 to be cleaned and recovered. Alternatively, each reagent may be separated and then each reagent may enter a separate reagent recovery system (not shown). For example, non-limiting examples of suitable techniques for separating the two or more reagents may include vacuum distillation, freezing, precipitation of one of the components by changing the pH of the mixture, or the like.

The recovered reagents may be utilized in any number of processes. For example, in some embodiments, the recovered reagent may be provided to one or more of the same process chamber or a different process chamber to perform a process using only recovered reagents. In some embodiments, the recovered reagent may be mixed with a fresh reagent and may be provided to one or more of the same process chamber or a different process chamber to perform a process. In some embodiments, the fresh reagent may have a different chemical composition from the recovered reagent. In some embodiments, recovered reagents have different chemical compositions may be mixed together and provided to the same or a different process chamber to perform a process. In some embodiments, the recovered reagent or a mixture of recovered reagents, or a mixture of a recovered reagent and a fresh reagent may be anhydrous. In some embodiments, the recovered reagent or a mixture of recovered reagents, or a mixture of the recovered reagent and a fresh reagent may have a water concentration ranging from about 0 to almost 100 percent.

In some embodiments, the byproduct species which are separated from the unreacted reagents by the scrubber 202 may include byproducts which may be converted into reagents under some conditions. Accordingly, those byproduct species separated by the scrubber 202 may be provided to the abatement system 108 as shown in FIG. 2. The abatement system 108 may operate to convert at least a portion of the byproduct species into useable reagents, for example, such as HF or the like. The abatement system 108 may also be utilized to process other types of effluents from the process chamber 102 and/or other process chambers coupled to the abatement system 108. In some embodiments, the abatement system 108 can utilize and effluent from another component of the FAB line, for example such as hydrogen (H₂), as a fuel to react with the byproduct species to form a useable reagent. As an alternative to the exemplary embodiments illustrated in FIG. 2 (not shown), the abatement system 108 may receive the effluents from the process chamber 102 directly, and after processing in the abatement system 108, the processed effluents may be directed to the reagent recovery system 106. In some embodiments, one or more of ozone (O₃) or oxygen (O₂) in combination with ultraviolet (UV) light and/or hydrogen peroxide (H₂O₂) may be utilized to oxidize and remove organic impurities from the effluents.

The abatement system 108 may be any suitable abatement system for receiving and processing an effluent from a semiconductor process chamber, for example, the process chamber 102, or a byproduct species from the scrubber 202. The abatement system 108 may be employed to abate a single process chamber or tool, or multiple process chambers and/or tools. The abatement system 108 may use, for example, thermal, wet scrubbing, dry scrubbing, filtration, (chemical or physical adsorption or absorption of impurities), catalytic, plasma and/or similar means for the treatment of the effluent, as well as processes and or reagent additions for converting the effluent to less toxic forms, or other forms such as HF to be used as a reagent in the reagent source 104, or other components of the FAB line. The abatement system 108 may further include multiple abatement systems (not shown) for processing particular types of effluents or byproduct species from the process chamber 102 or scrubber 202. For example, one of the multiple abatement systems could be specifically tasked for converting fluorine-containing effluents to hydrogen fluoride (HF), and a second abatement system could be used for abating the effluent from, for example, a cleaning process.

The abatement system 108, for example, may include one or more of a hydrogenation reactor 208, a thermal reactor 210 (i.e., combustion reactor), or the like (illustrated in FIG. 2). The example in FIG. 2 shows two abatement devices (e.g., the hydrogen reactor 208 and the thermal reactor 210) in series. In some embodiments (not shown), the two abatement devices (for example, the hydrogenation reactor and the thermal reactor) could be disposed in parallel with switching valves provided to divert the fluorine-containing effluents (e.g., F₂ and/or HF from a etch process) to one abatement device (such as the hydrogenation reactor 208) and the process (e.g., cleaning) effluent to a second abatement device (e.g., the thermal reactor 210). In some embodiments, the abatement system includes either a thermal reactor or a hydrogenation reactor converting at least a portion of the effluents (e.g., from the process chamber 102) and/or byproduct species (e.g., from the scrubber 202) to useable reagents and additional byproduct species. Additional byproduct species may include, for example, those portions of the effluents and/or byproduct species not converted into useable reagents. Additional byproduct species may include solid materials, such as silicon dioxide (SiO₂) particulates, or water-soluble or reactive materials, such as dissolved silica species, HF, HCl, NF₃, CF₄, SiH₄, H₂, CO, CO₂, trimethylborate (TMB), tetraethoxysilane (TEOS), PH₃, CH₄, phosphorous oxides, or boron oxides.

A portion of the effluent exhausted from a chamber or the byproduct species from the scrubber may include, for example, fluorine (F₂). The effluent or byproduct species may be initially injected into hydrogenation reactor 202 which can be used to convert halogens (e.g., F₂) into hydrogen-containing gases (e.g., HF). The hydrogenation reactor 202 is not limited to processing fluorine-containing effluent.

Alternatively or in combination with the hydrogenation reactor 202, the abatement system 106 may further comprise the thermal reactor 204. For example, the thermal reactor 204 may be utilized to process a portion of the fluorine-containing effluents, for example, such as effluents comprising silicon and fluorine, such as silicon tetrafluoride (SiF₄). For example, the fluorine-containing effluent can be injected into the thermal reactor 204 to convert, for example, a fluorine-containing effluent (e.g., SiF₄) into a hydrogen-containing gas (e.g., HF) and an oxygen-containing material (e.g., SiO₂). An exemplary thermal reactor may, for example burn effluent, such as SiF₄ in an atmosphere of an oxygen-containing gas such as water (H₂O) vapor to form hydrogen fluoride (HF) and silicon dioxide (SiO₂) which can be separated by, for example, a scrubber as discussed below.

In some embodiments, for example, when the byproduct species originated at the scrubber 202 and was directed to the abatement system 108 for further processing, the useable reagents and additional byproduct species formed in the abatement system 108 may be directed back to the scrubber 202 for further processing as illustrated in FIG. 2.

Returning to FIG. 1, the controller 112 may coupled to the process chamber 102 for controlling the operation thereof. The controller 112 may be the controller for operating the system 100, or portions thereof, or it may be a separate controller. The controller 112 generally comprises a central processing unit (CPU), a memory, and support circuits for the CPU (not shown). The controller 112 may control the process chamber 102 directly (e.g. via a digital controller card), or via computers (or controllers) associated with particular process chamber and/or the support system components. The controller 112 may be one of any form of general-purpose computer processor that can be used in an industrial setting for controlling various chambers and sub-processors. The memory, or computer-readable medium of the CPU may be one or more of readily available memory such as random access memory (RAM), read only memory (ROM), floppy disk, hard disk, flash, or any other form of digital storage, local or remote. For example, instructions for performing the methods disclosed herein may be stored in the memory of the CPU, and when executed, perform the method. The support circuits are coupled to the CPU for supporting the processor in a conventional manner. These circuits may include cache, power supplies, clock circuits, input/output circuitry and subsystems, and the like.

Embodiments of the present invention as described above may be advantageous for several reasons. For example, embodiments of the present invention may advantageously allow for minimal storage of reagents, such as HF, on site by generating or regenerating the reagents as needed/consumed. The reagents can be generated in relatively close proximity to the chamber minimizing the volume of reagent within the processing system. The inventive processing system further minimizes the need to transport large quantities of HF (or other hazardous reagents) on roads or shipping lanes.

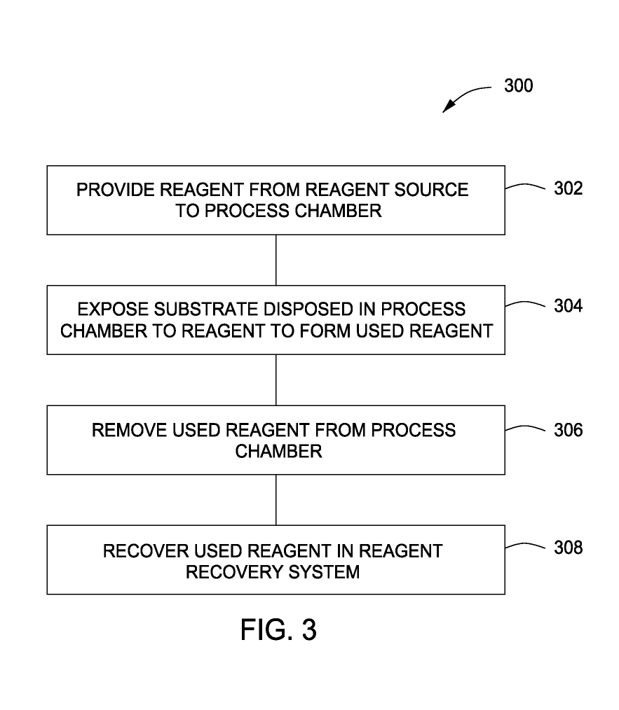

FIG. 3 depicts a flow chart for a method of recovering a reagent in accordance with some embodiments of the present invention. For example, the method may be part of a chamber cleaning process performed when the chamber is idle (e.g., not processing substrates), or may be performed when the chamber is in operation, such as chemically etching a substrate or the like. The method 300 is described below with respect to FIG. 1, however, the method may be utilized with any embodiments of the processing system as discussed above.

The method generally begins at 302 by providing reagent from a reagent source to a process chamber. For example, reagent may be provided from the reagent source 104 to the process chamber 102. The process chamber 102 may be in an idle mode and ready for a cleaning process, or in an operational mode. For example, the substrate 118 may be disposed within the process chamber 102 for processing, or alternatively, no substrate may be present. The reagent source 104 may provide a reagent via the incoming fluid line 122 to the nozzle 120 and into a processing volume of the process chamber. Optionally, as discussed above, the reagent may be heated by the thermal control device 124 to a desired temperature for processing.

Next, at 304, a substrate disposed in the process chamber may be exposed to the reagent, forming a used reagent. Alternatively, when no substrate is present (for example during a chamber cleaning process), chamber components within the process chamber 102 may be exposed to the reagent and may form the used reagent. The used reagent may include unreacted reagent. The reagent may be utilized in the process chamber 102, for example, as part of a chamber cleaning process, chemical etch process, or the like. The reagent may react with contaminants, such as those formed from substrate materials, chamber components or materials disposed on the chamber components, gases present within the process chamber, other reagents, or the like. The contaminants may be included in an effluent, which is removed from the process chamber via the waste effluent line 107. The effluent can further include the used reagent, as discussed above.

At 306, the used reagent may be removed from the process chamber 102 and directed to the reagent recovery system 106. At 308, the used reagent may be recovered in a reagent recovery system. For example, the unreacted reagents in the effluent may be separated from the contaminants, for example, such as insoluble and soluble byproduct species by the reagent recovery system 106. For example, the unreacted reagent and water soluble byproducts are separated from the insoluble byproducts by the scrubber 202 and the unreacted reagent is separated by the water soluble byproducts by the vacuum distillation apparatus 204 and/or other apparatus as discussed above. Optionally, the concentration of the recovered reagent may be adjusted using the bubbler 208.

Once the reagent is recovered (e.g., collected, and optionally purified and/or concentrated) the recovered reagent may be reused. For example, the recovered reagent may be provided to the reagent source 104 for ultimate delivery to the process chamber 102, or to another process chamber (or another reagent source). As discussed above, other optional steps of the method 300 are possible. For example, insoluble byproducts collected at the scrubber 202 may be directed to the abatement system 106 to convert at least a portion of the insoluble byproducts to useable reagents which may be directed back to the scrubber 202 for collection.

Thus, methods and apparatus for the recovery and reuse of reagents have been provided. At least some embodiments of the inventive methods and apparatus may advantageously provide for recovering used reagent for reuse. In some embodiments, the inventive methods and apparatus may advantageously convert byproduct species from an exhausted effluent into useable reagents. At least some embodiments of the inventive methods and apparatus may reduce the need for production, transportation, and/or storage of hazardous chemicals (e.g., the reagents) by efficiently recovering used reagents from effluent process chamber for reuse.

While the foregoing is directed to embodiments of the present invention, other and further embodiments of the invention may be devised without departing from the basic scope thereof.

1. A system for processing substrates, comprising:
a process chamber for processing a substrate;
a reagent source coupled to the process chamber to provide a reagent to the process chamber; and
a reagent recovery system to collect, and at least one of purify or concentrate the reagent recovered from an effluent exhausted from the process chamber.

2. The system of claim 1, wherein the reagent recovery system is coupled to the process chamber.

3. The system of claim 1, further comprising:
a conduit for providing the recovered reagent to at least one of the reagent source or to a second process system.

4. The system of claim 1, wherein the reagent includes at least one of hydrofluoric acid (HF), nitric acid (HNO₃), or phosphoric acid (H₃PO₄).

5. The system of claim 1, further comprising:
an abatement system coupled to the process chamber to abate effluent exhausted from the process chamber.

6. The system of claim 5, wherein the abatement system further comprises:
at least one of a thermal combustion apparatus or a hydrogen injection apparatus for converting at least a portion of the exhaust effluent into useable reagent.

7. The system of claim 5, wherein the reagent recovery system is integrated with the abatement system.

8. The system of claim 5, wherein the abatement system is further configured to abate a fluorine-containing effluent exhausted from the process chamber and to convert at least a portion of the fluorine-containing effluent into hydrogen fluoride (HF).

9. The system of claim 1, wherein the reagent recovery system further comprises:
a scrubber for separating the unreacted reagent from at least a insoluble portion of the exhausted effluent by solubilizing the unreacted reagent.

10. The system of claim 9, wherein the reagent recovery system further comprises:
a vacuum distillation apparatus for separating the solubilized unreacted reagent from a remaining portion of the exhausted effluent.

11. The system of claim 9, wherein the remaining portion of the exhausted effluent includes water-soluble byproduct species.

12. The system of claim 9, where the reagent recovery system further comprises:
a bubbler for adding water (H₂O) to the distilled unreacted reagent to a concentration suitable for use in the reagent source.

13. A system for processing substrates, comprising:
a process chamber for processing a substrate with a liquid reagent;
a reagent source coupled to the process chamber to provide the liquid reagent to the process chamber; and
a reagent recovery system to collect reagent removed from the process chamber and to purify and adjust the concentration of the collected reagent to a concentration and purity suitable for use in the process chamber.

14. A method for recovering unreacted reagent, comprising:
providing reagent from a reagent source to a process chamber;
exposing a substrate disposed in the process chamber to the reagent, forming an effluent;
exhausting the effluent from the process chamber; and
recovering unreacted reagent from the effluent in a reagent recovery system.

15. The method of claim 14, wherein the reagent recovery system is coupled to the process chamber.

16. The method of claim 14, wherein the effluent includes the unreacted reagent and byproduct species, and wherein recovering the unreacted reagent from the effluent further comprises:
separating the unreacted reagent from the byproduct species in the reagent recovery system.

17. The method of claim 16, wherein recovering the unreacted reagent further comprises:
adjusting the concentration of the separated unreacted reagent.

18. The method of claim 14, further comprising:
providing the recovered unreacted reagent to the reagent source.

19. The method of claim 14, further comprising:
providing the recovered unreacted reagent to a second reagent source coupled to a second process chamber.

20. The method of claim 14, wherein the reagent comprises at least one of hydrofluoric acid (HF), nitric acid (HNO₃), or phosphoric acid (H₃PO₄).
